(19) United States
(12) Patent Application Publication
(10) Pub. No.: US 2010/0233555 A1
(43) Pub. Date: Sep. 16, 2010

(54) CLOSED-LOOP CONTROL SYSTEM FOR A CONTROLLED SYSTEM

(76) Inventors: Daniel Zirkel, Stuttgart (DE); Gunter Wiedemann, Ludwigsburg (DE); David Schlipf, Buehlertann (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/621,113

(22) Filed: Nov. 18, 2009

(30) Foreign Application Priority Data
Nov. 19, 2008 (DE) 10 2008 043 869.3

(51) Int. Cl. H01M 8/04; G05B 13/02

(52) U.S. Cl. 429/428; 700/12; 700/42; 700/41

(57) ABSTRACT

The invention relates to a closed-loop control system for a controlled system for specifying at least one controlling variable to the controlled system, having a primary controller, for generating the controlling variable within an interval between a maximum controlling variable barrier and a minimum controlling variable barrier. At least one measuring means for determining a controlled variable of the controlled system is provided. At least one measurement system for ascertaining at least one state variable of the controlled system, and at least one secondary controller, for varying the maximum controlling variable barrier and the minimum controlling variable barrier as a function of the state variable are provided.

### CROSS-REFERENCE TO RELATED APPLICATION

This application is based on German Patent Application 10 2008 043 869.3 filed Nov. 19, 2008.

### BACKGROUND OF THE INVENTION

1. Field of the Invention

The invention relates to a closed-loop control system for a controlled system, and to a control method for a controlled system.

2. Description of the Prior Art

Closed-loop control systems are often used in the prior art for regulating technical processes. A controller of the closed-loop control system serves to vary one or more physical variables to a predetermined level. In industrial applications, the linear PI controller is often used. The wide distribution of the PI controller is explained by the fact that adjusting it requires no complex mathematical models. However, the PI controller has the disadvantage that only a controlled variable is regulated with a controlling variable. Other variables of the controlled system to be regulated can overshoot or undershoot permissible values. PI controllers until now have been able to employ limitations of the controlling variables only through massive losses of the control quality. For instance, a gradient limitation in the controlled variable in the sense of pilot control is known for making a violation of a controlling variable limitation unlikely. Because of the absence of feedback of the state variable, however, this feature does not offer reliable realization and can significantly worsen the guide behavior, since the limitation of the controlled variable must be designed for the worst case in each situation.

### OBJECT AND SUMMARY OF THE INVENTION

The object of the present invention is to disclose a closed-loop control system for a controlled system which overcomes the aforementioned disadvantages, and in particular to describe a closed-loop control system without losses of control quantity in the non-limited range.

According to the invention, a closed-loop control system for a controlled system for specifying at least one controlling variable to the controlled system is disclosed, having a primary controller, for generating the controlling variable within an interval between a maximum controlling variable barrier and a minimum controlling variable barrier; at least one measuring mechanism for determining a controlled variable of the controlled system; at least one measurement system for ascertaining at least one state variable of the controlled system; and at least one secondary controller, for varying the maximum controlling variable barrier and the minimum controlling variable barrier as a function of the state variable.

The nucleus of the closed-loop control system of the invention as well as of the control method is that the two controlling variable barriers are varied as a function of a state variable of the controlled system to be regulated. Conventional controllers can output arbitrary manipulated variables between a maximum controlling variable barrier and a minimum controlling variable barrier. As described, only by means of elements that worsen the control quality can the manipulated variable be prevented in the prior art from violating the controlling variable barrier. According to the invention, a state variable of the controlled system is now measured and evaluated. As a function of this defined state variable, a variation of the controlling variable barriers takes place. Thus the controlling variable barriers are adapted dynamically to the state of the controlled system to be regulated.

By means of the invention, it is possible to regulate a controlled system using a standard controller and at the same to eliminate violations of state limitations by adapting the controlling variable barriers of the controller. Since the regulation is often optimal along state limitations, it is thus possible to move the controlled variable without sacrificing control quality and without reversing closed-loop control circuits; eliminating the violation of state limitations is given priority over regulating the controlled variable. Thus the closed-loop control system according to the invention has a constructive simplicity that distinguishes it from known methods and closed-loop control systems.

In the context of the invention, it is the part of a closed-loop control circuit whose controlled variable is to be regulated with a controlling variable that is known as a controlled system. The controlled system itself does not contain the controller. In the context of the invention, the controlled system is a closed feedback system which comprises at least one controlled system, a controller, and the feedback. What is definitive for a closed-loop control circuit is the closed operating circuit with negative feedback. In the invention, the closed-loop control circuit is also called a closed-loop control system. The controlled variable of a closed-loop control circuit is the variable to be regulated, which is usually a measured value but can also be some other variable that can be varied. If the variable deviates from the desired value (also called the command variable), then the attempt is made to eliminate this control difference by means of a controller.

The controller automatically, in a usually technical process varies one or more physical variables to a predetermined level, reducing interference factors. To do so, the controller compares the signal of the set-point value on an ongoing basis with the measured and fed-back actual value of the controlled variable and from the difference between the two variables ascertains a controlling variable, which varies the controlled system in such a way that the standard deviation in the steady state, is minimized.

In the context of the invention, the manipulated variable, also called a controlling variable, is the variable calculated by the controller from the control difference between the desired value and the actual value. This variable is located at the output of the controller. With this variable, the factors in the controlled system are triggered in order to compensate for the existing control difference.

An advantageous variant embodiment of the closed-loop control system according to the invention is distinguished in that the primary controller and/or at least one of the secondary controllers has an I, PI, or PID controller core. An I controller is a controller with at least one integral member. A PI controller has at least one integral and at least one proportional member. A PID controller, in comparison to a PI controller, additionally has at least one differential member.

In a further advantageous feature, it is provided that the primary controller generates to controlling variable within a controller interval between a maximum controlling variable limit and a minimum controlling variable limit, and the interval between the controlling variable barriers is located within the controller interval. This feature has the advantage that despite adaptation of the controlling variable barriers, these controlling variable barriers do not overshoot the controlling variable limits predetermined by the primary controller. The primary controller has mechanical and/or electronically predetermined controlling variable limits. They describe the maximum or minimum magnitude of the controlling variable signal to be generated by the primary controller. Within this controller interval predetermined by the controlling variable limits, the controlling variable barriers can be varied freely as a function of the state variable. For easier comprehension, the following nomenclature will be used:

maximum controlling variable barrier u_max or uₘₐₓ

minimum controlling variable barrier u_min or uₘᵢₙ

maximum controlling variable limit u_max_real or uₘₐₓ_{_{—}}ᵣₑₐₗ

minimum controlling variable limit u_min_real or uₘₐₓ_{_{—}}ᵣₑₐₗ

Thus for the controlling variable limits and controlling variable barriers, the following relationship pertains:

u_min_real≦u_min<u_max≦u_max_real.

A further advantageous variant embodiment provides that the primary controller and/or at least one of the secondary controllers is embodied such that an integrator windup is avoidable if the controlling variable reaches the maximum controlling variable barrier or the minimum controlling variable barrier or the maximum controlling variable limit or the minimum controlling variable limit. In controllers, if the controlling variable limitation is overshot (the controlling variable output of the controller exceeds the physical limits of the final control element), a windup effect can occur. The controller assumes a value above the possibilities for the final control element and on the return causes unwanted delays. This is counteracted with the limitation to the controlling variable limits (anti-windup). This has the advantage that the controlled variable, even if the associated controlling variable was located in the controlling variable limitation before, reacts rapidly to a change of sign of the particular control difference at the input to the controller. The reason for this is that the change in the controlling variable, immediately after the reversal of the sign of the control difference, reverses its sign, since the so-called integrator windup, that is, a runup of the integrator of a PI or PID controller while the controlling variable is located in its limitation, is avoided.

It has proved advantageous if the closed-loop control system has a model module, and the model module has a model of the controlled system. The model module serves to generate information about the controlled system. In the model module, a mathematical model of the controlled system can for instance be stored in memory. The model is thus a mathematical and in particular functional or statistical copy of the controlled system. This has the advantage that measured state variables which have been ascertained by means of the measurement system can be compared with state variables calculated in the model. This comparison of the measured and calculated state variables allows a precise variation of the maximum and minimum controlling variable barriers. In particular a nonlinear behavior of the controlled system as a function of the state variable and/or of the controlling variable can be stored in memory in the model. Accordingly, an adaptation of the controlling variable barriers is possible after comparison with the model. Additionally or alternatively, it is possible for the information obtained with the model to be combined with the measured state variable in order to attain a variation of the controlling variable barriers. Consequently, the measured controlling variable is only one part of the information that is taken into account in the variation of the controlling variable barriers. On the basis of the at least one ascertained state variable, comparisons are made with the model and/or further, nonmeasured state variables of the controlled system are calculated. By means of a combination of the state variables thus ascertained, a precise variation of the controlling variable barriers can then be done.

It has proved especially advantageous if the closed-loop control system is used for regulating a fuel cell. Consequently, within the scope of the invention, a fuel cell system with at least one fuel cell is also claimed, and the fuel cell system has at least one closed-loop control system in accordance with one of the variant embodiments described above.

The object according to the invention is also attained by a control method for a controlled system, wherein a controlling variable is generated; the controlling variable is generated within an interval between a maximum controlling variable barrier and a minimum controlling variable barrier; on the basis of the controlling variable, at least one state variable of the controlled system is ascertained; at least one of the maximum controlling variable barrier and the minimum controlling variable barrier is changed as a function of the state variable; and the controlling variable is converted by the controlled system into a controlled variable.

Characteristics and details that have been disclosed in conjunction with the closed-loop control system of the invention also apply in conjunction with the control method of the invention, and vice versa. Once again, the special feature is that a state variable of the controlled system is ascertained, and this varies the controlling variable barriers. Thus a dynamic adaptation of the interval in which the controlling variable can be generated is possible.

A further advantageous method step provides that the controlling variable is generated within a controller interval between a maximum controlling variable limit and a minimum controlling variable limit, and the interval between the controlling variable barriers is located within the controller interval. By means of this method step, it is assured that the controlling variable barriers are changed only within the predetermined controller interval. The controller interval itself is predetermined by the intrinsic properties of the primary controller. The controller interval is a limitation predetermined by the mechanical and/or electronic properties of the primary controller and/or of the controlled system. The method step thus assures that despite the dependency of the minimum and maximum controlling variable barriers on the at least one state variable, they are still always located within the controller interval. That means that even a theoretically possible change in the controlling variable barriers beyond the limitations predetermined by the controller interval will not be performed. It is thus assured that no controlling variable barriers are generated that are located outside the controller interval predetermined by the primary controller.

An advantageous variant of the control method is distinguished in that the maximum controlling variable barrier is calculated as follows:

$${u}_{max} = {u}_{max\_real} - max [ {\sum }_{ip} Δ {u}_{max , ip} , {u}_{max\_real} - {u}_{min} ]$$

It has also proved advantageous if the minimum controlling variable barrier is calculated as follows:

$${u}_{min} = {u}_{min\_real} + min [ {\sum }_{in} Δ {u}_{min , ip} , {u}_{max} - {u}_{min\_real} ]$$

The abbreviations have the following meanings:
min (a, b)=the minimum of a and b
max (a, b)=the maximum of a and b
Σᵢₙ=the sum, with the running index i pertaining to the negative limitations;
Σᵢₚ==the sum, with the running index i pertaining to the positive limitations;
Δu_{max, in} is an output signal of a secondary controller for a negative gain of the controlled system;
Δu_{max, ip} is an output signal of a secondary controller for a positive gain of the controlled system.

It has also proved advantageous if the controlled system and/or the state variable is modeled. By means of a mathematical and/or statistical representation of the controlled system and/or of the state variable in a model, conclusions can be drawn about the variation of the controlling variable barriers. It is thus possible from the very outset in particular to plan for nonlinear modes of behavior of the controlled system and to make suitable adaptations of the controlling variable barriers possible.

It has also proved advantageous if the closed-loop control system described above is used for performing the control method also described above.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a closed-loop control system according to the invention;

FIG. 2 shows a fuel cell system;

FIG. 3 shows an anode path of the fuel cell system;

FIG. 4 shows the anode path with an integrated closed-loop control system according to the invention; and

FIG. 5 is a schematic diagram for the calculation of a controlling variable limitation.

### DESCRIPTION OF THE PREFERRED EMBODIMENTS

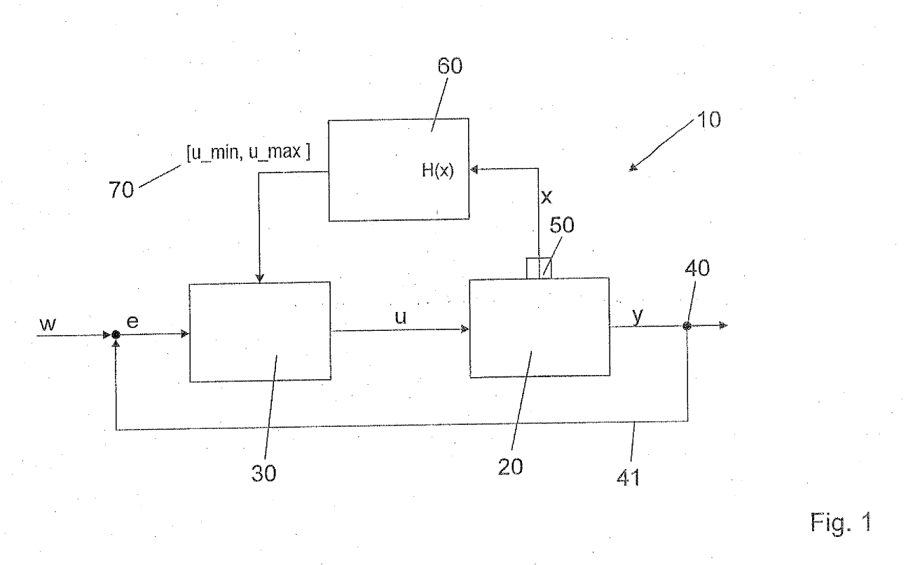

In FIG. 1, a closed-loop control system 10 according to the invention is shown. The closed-loop control system 10 serves to regulate a controlled system 20. The closed-loop control system 10 has a primary controller 30. This primary controller 30 serves to generate a controlling variable u, which acts on the controlled system 20. As a function of the controlling variable u, the controlled system 20 generates a controlled variable y. In FIG. 1 as shown, the controlled system 20 serves to represent an arbitrary system that is to be regulated. The controlled system 20 can consequently be an arbitrary mechanical and/or electronic element, which is controlled with the aid of the closed-loop control system 10 of the invention. Below, a fuel cell, and in particular an anode path of a fuel cell system, will be described as the controlled system 20. A measuring means 40 is connected to the controlled system 20. This measuring means 40 serves to determine the controlled variable y of the controlled system 20. In the exemplary embodiment shown, the measuring means 40 is connected to a negative feedback 41. This negative feedback 41 serves to feed at least a portion of the controlled variable y back to the set-point value and there to determine a control difference e. By feedback of the controlled variable y, the controlled variable acts counter to the predetermined set-point value w.

A measurement system 50 is integrated with or disposed on the controlled system 20. The measurement system 50 serves to ascertain at least one state variable x of the controlled system 20. It is thus the task of the measurement system 50 to determine the state variable x that characterizes the controlled system 20. The state variable x is correlated directly or indirectly with the controlled variable y. The primary controller 30 has a maximum controlling variable limit u_max_real and a minimum controlling variable limit u_min_real. As a function of the predetermined set-point value w, the controlling variable u can be varied between the maximum controlling variable limit and the minimum controlling variable limit. Both controlling variable limits are determined by intrinsic properties of the primary controller 30. These may be electronic and/or mechanical properties of the primary controller 30 that define these controlling variable limits. The controlling variable can be allowed to fluctuate only between the predetermined controlling variable limits:

u_min_real≦u≦u_max_real.

For attaining the aforementioned object of the invention, it is now provided that the closed-loop control system 10 has a secondary controller 60. The secondary controller 60 is connected to the measurement system 50 on one side and to the primary controller 30 on the other. The special feature according to the invention is that the secondary controller performs a variation of a maximum controlling variable barrier u_max and a minimum controlling variable barrier u_min as a function H(x) of the state variable x. The maximum and minimum controlling variable barriers of the interval 70 are variable limits for the controlling variable u within the controller interval predetermined by the controlling variable limits. Consequently, the controlling variable barriers must be located within the controller interval defined by the controlling variable limits:

u_min_real≦u_min≦u≦u_max≦u_max_real.

Thus a dynamic adaptation of the controlling variable barriers to the state variable is possible.

The measurement system 50 determines a state variable x from the controlled system 20. To attain optimal regulation of the controlled system 20, predetermined limitations may be present. In the context of the example described here, it is assumed that the limitation to be adhered is as follows:

Hᵢ(X)≦0.

Consequently, it is to be assumed that the dependency H(x) on the state variable should always be less than or equal to zero. For each limitation Hᵢ(X), is must be clarified whether a violation of the aforementioned limitation can be eliminated by means of increasing or decreasing the controlling variable u. For an i^{th} limitation Hᵢ_{_{—}}ₚ(X) with positive gain over the control range of u, each secondary controller 60 generates a difference Δuₘₐₓ, ip, which is subtracted from the maximum controlling variable limit. The result is then the new maximum controlling variable barrier. For an i^{th} limitation Hᵢ_{_{—}}ₙ(X) with negative gain over the control range of u, each secondary controller 60 generates a difference Δu_{min, in}. This is added to the minimum controlling variable limit in order to calculate the new minimum controlling variable barrier. Consequently, the controlling variable barriers for the primary controller 30, given a plurality of state limitations x that are each determined with a measurement system 50, the following mathematical relationships result:

$${u}_{max} = {u}_{max\_real} - max [ {\sum }_{ip} Δ {u}_{max , ip} , {u}_{max\_real} - {u}_{min} ]$$

$${u}_{min} = {u}_{min\_real} + min [ {\sum }_{in} Δ {u}_{min , ip} , {u}_{max} - {u}_{min\_real} ]$$

By means of this combination of two controllers, both guide behavior and the elimination of state limitations can be attained in a simple way because the band of the primary controller 30 within which the controlling variable u can be influenced is restricted. By the use of anti-windups, the integrators of the controllers are tracked and guarantee a calm course of the controlling variable.

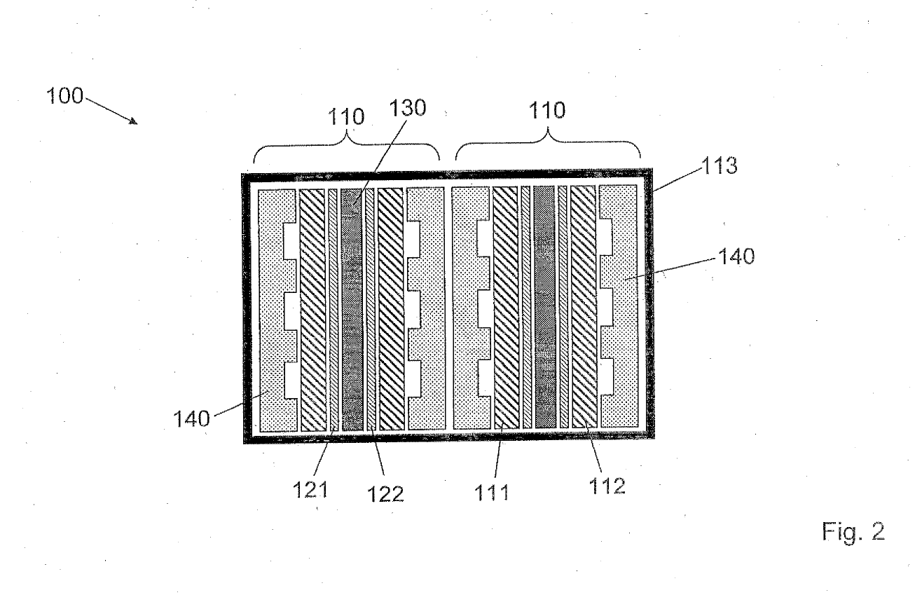

To illustrate the usefulness of the closed-loop control system 10, a fuel cell system 100 or a fuel cell 110 will serve as the controlled system 20. In FIG. 2, one such fuel cell system 100 is shown, which here has two fuel cells 110. These fuel cells 110 are disposed adjacent one another in a housing 113. Each of the fuel cells 110 has a first electrode element 121 and a second electrode element 122. An ion-permeable membrane 130 is disposed between the two electrode elements 121, 122. Each of the two electrode elements 121, 122 has its own electrode chamber 111, 112. By subjecting the electrode elements 121, 122 to two different reactands, an electric current is generated by means of an electrochemical reaction. The two reactands are often furnished in the form of different fluids. One example for the two corresponding electrode reactions are the following:

H₂=>2H⁺+2e⁻ (anode reaction)

2H⁺+2e⁻+½O₂=>H₂O (cathode reaction)

The electric current obtained can be consumed in a load element. The reactand oxygen can be supplied to the fuel cell in the form of ambient air. To attain a uniform distribution of the reactands to the electrode elements, each of the electrode chambers of the fuel cell 110 has a flow field plate 140.

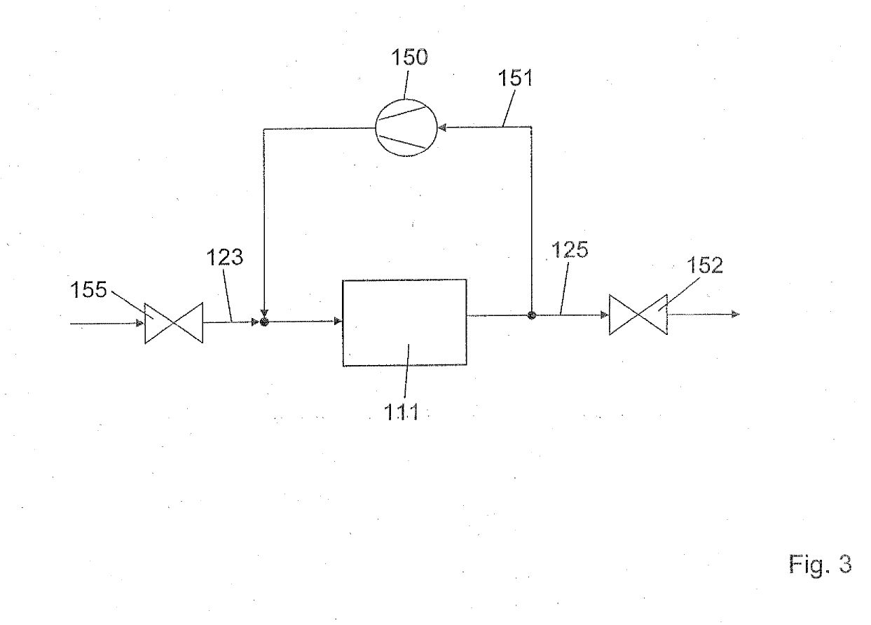

In FIG. 3, an anode path of a fuel cell system 100 is shown. What is schematically shown is the first electrode chamber 111—also called the anode chamber—in which the reactand—such as hydrogen—is introduced via a supply line 123. The electrochemical reaction then takes place inside the first electrode chamber 111. Via an inlet valve 155, the quantity of the reactand that is supplied to the first electrode chamber 111 is regulated. In general, the quantity of the supplied reactand is greater than what is converted electrochemically. However, the unconsumed reactand is not emitted via an outlet valve 152 into the surroundings of the fuel cell. Instead, for reasons of efficiency, the unconsumed reactand is fed back to the supply line 123 by means of a return line 151 and a recirculation element 150. The recirculation element 150 generally has a blower, which assures that the reactand is supplied in compressed form to the supply line 123 and can then flow into the first electrode chamber 111 again.

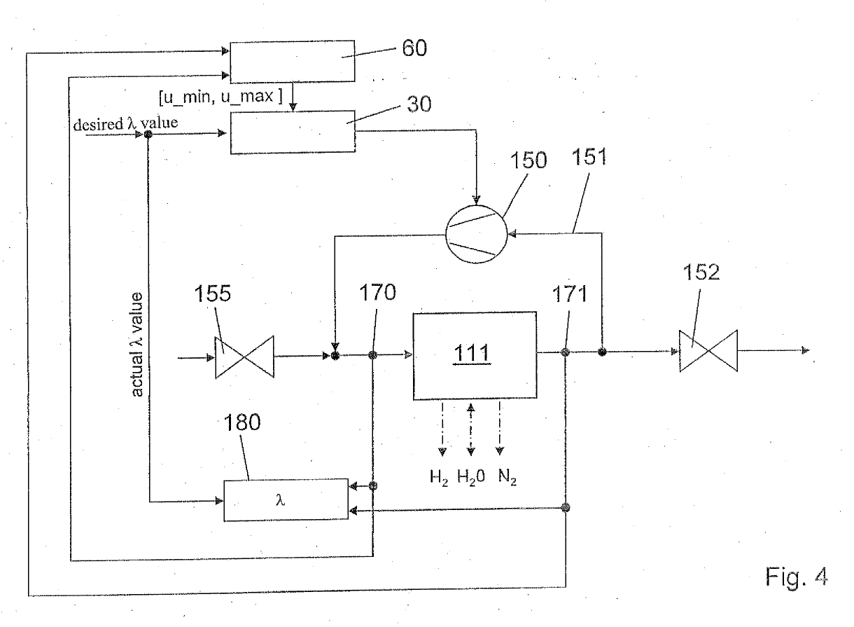

The integration of the closed-loop control system 10 according to the invention with the anode path is shown in FIG. 4. The first electrode chamber 111 and the recirculation element 150 can be seen. According to the invention, the fuel cell 110 and in particular the first electrode chamber 111, and preferably the first electrode chamber 111 with a recirculation element, form the controlled system 20 (FIG. 1) that is to be regulated by means of the closed-loop control system 10 of the invention. A first pressure meter 170 determines the pressure p₁ at which the reactand is introduced into the first electrode chamber 111. A second pressure meter 171 determines the so-called afterpressure p₂ at which the reactand emerges from the first electrode chamber 111. The regulation to a load-dependent pilot pressure, which is determined by means of the first pressure meter 170, takes place via the inlet valve 155. In the first electrode chamber 111, when the outlet valve 152 is closed, nitrogen and possibly water accumulate, so that gas recirculation by the recirculation element 150 is necessary. As a standard for the necessary recirculation, the requisite stoichiometry lambda between the quantity of the supplied reactand and the reactand consumed in the first electrode chamber 111 for stable operation can be used. According to the invention, the stoichiometry can be regulated via the closed-loop control system 10. For that purpose it is provided that the first pressure meter 170 determines a first pressure p₁, and the second pressure meter 171 determines a second pressure p₂. In an arithmetic element 180, the stoichiometry lambda is calculated from these pressures. The arithmetic element 180 may be an integrated circuit which is designed for determining the stoichiometry from the pressure information p₁, p₂ and from the mass flow through the fuel cell. The information thus generated is returned as lambda_to the input to the primary controller 30. There, a comparison is made with the established desired lambda value, whereupon a regulation of the recirculation blower is effected via the controlling variable u. Consequently, the recirculation blower is that element of the fuel cell system 100 that is controlled by the primary controller 30 by means of the controlling variable u. The secondary controller 60 according to the invention likewise receives both pieces of information about the pressure p₁, p₂. By means of mathematical functions and/or mathematical models of the first electrode chamber 111 and/or of the fuel cell 110, controlling variable barriers for the primary controller 30 are calculated. These controlling variable barriers (u_min, u_max) are forwarded to the primary controller 30 and limit the output of the controlling variable u.

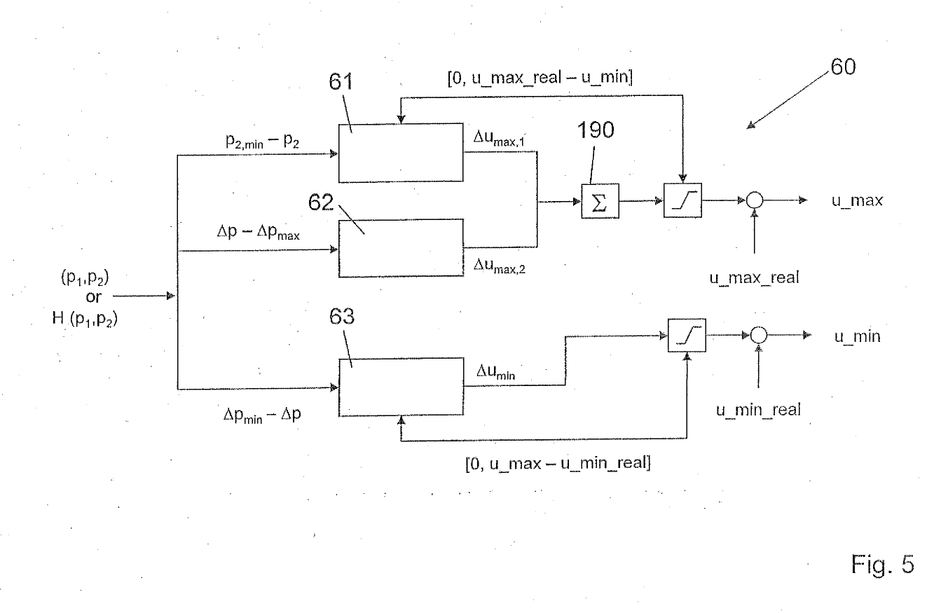

In order to better describe the control method and the closed-loop control system 10 according to the invention, a calculation of the controlling variable barriers will be described below taking as an example a lambda regulation for an anode path. However, this example should not be understood as a restriction but instead serves solely to illustrate the method of the invention and the closed-loop control system of the invention. For that purpose, FIG. 5 shows a schematic diagram of the elements of the secondary controller 60. This secondary controller 60 has three integrated PI controllers 61, 62 and 63 with an anti-windup function. To ensure uniform, safe operation of the fuel cell 110, three limitations must be adhered to:

1. The afterpressure p₂ must not drop below a defined minimum pressure p₂ₘᵢₙ.

2. The pressure difference Δp=p₁−p₂ must not exceed a defined maximum value Δpₘₐₓ.

3. The pressure difference Δp=p₁−p₂ must not undershoot a defined minimum value Δpₘᵢₙ.

According to the invention, it is provided that a violation of one of the aforementioned limitations is counteracted by means of increasing or reducing the rpm of the recirculation element. As a result, the pressure at which the reactand in the return line 151 (FIG. 3) is fed to the supply line 123 can be changed. Since the quantity of the first reactand fed by the recirculation element 150 is dependent on the rpm at which an electric motor inside the recirculation element 150 is operated, violations of one of the aforementioned limitations can be counteracted:

1. By rpm reduction, in order to increase the afterpressure p₂ again, if the pressure p₁ is kept constant.

2. By rpm reduction, in order to lower the pressure difference Δp=p₁−p₂.

3. By increasing the rpm, in order to raise the pressure difference Δp=p₁−p₂.

The rpm of the recirculation element 150 is controlled by the controlling variable u, which is generated by the primary controller 30. For this controlling variable u, it is intended that it must be within controlling variable limits:

u_min_real≦u≦u_max_real.

For the three limitations named above, functions H can now be formed, which are dependent on the two pressures p₁ and p₂, and for which the relationship H(p₁, p₂)≦0 applies. Thus the following three functions result:

H₁ₚ=p_{2,min}−p₂ 1.

H₂ₚ=Δp−Δpₘₐₓ 2.

H₁ₙ=Δpₘᵢₙ−Δp 3.

These three functions can be supplied to three PI controllers 61, 62 and 63 with anti-windup function. From the outputs, the results are the various variables, added to or subtracted from the maximum controlling variable limit, that produce the maximum or minimum controlling variable barrier. The maximum controlling variable barrier and the minimum controlling variable barrier can be calculated as follows:

$${u}_{max} = {u}_{max\_real} - max [ {\sum }_{ip} Δ {u}_{max , ip} , {u}_{max\_real} - {u}_{min} ]$$

$${u}_{min} = {u}_{min\_real} + min [ {\sum }_{in} Δ {u}_{min , ip} , {u}_{max} - {u}_{min\_real} ]$$

The variables ΔUₘₐₓ₁ and ΔUₘₐₓ₂ are added in an adder 190. Next, by means of a comparator element 200, it is ensured that the ascertained controlling variable barriers do not overshoot or undershoot the controlling variable limits. By means of this adjustment, the closed-loop control system 10 according to the invention enables a dynamic adaptation of the controlling variable harriers to the conditions actually present in the controlled system 20.

The foregoing relates to preferred exemplary embodiments of the invention, it being understood that other variants and embodiments thereof are possible within the spirit and scope of the invention, the latter being defined by the appended claims.

1-20. (canceled)

21. A closed-loop control system for a controlled system for specifying at least one controlling variable to the controlled system, having
a primary controller, for generating the controlling variable within an interval between a maximum controlling variable barrier and a minimum controlling variable barrier;
at least one measuring means for determining a controlled variable of the controlled system; at least one measurement system for ascertaining at least one state variable of the controlled system; and
at least one secondary controller, for varying the maximum controlling variable barrier and the minimum controlling variable barrier as a function of the state variable.

22. The closed-loop control system as defined by claim 21, wherein the primary controller and/or at least one of the secondary controllers has an I, PI, or PID controller core.

23. The closed-loop control system as defined by claim 21, wherein in that the primary controller generates to controlling variable within a controller interval between a maximum controlling variable limit and a minimum controlling variable limit, and the interval between the controlling variable barriers is located within the controller interval.

24. The closed-loop control system as defined by claim 22, wherein in that the primary controller generates to controlling variable within a controller interval between a maximum controlling variable limit and a minimum controlling variable limit, and the interval between the controlling variable barriers is located within the controller interval.

25. The closed-loop control system as defined by claim 21, wherein the primary controller and/or at least one of the secondary controllers is embodied such that an integrator windup is avoidable if the controlling variable reaches the maximum controlling variable barrier or the minimum controlling variable barrier or the maximum controlling variable limit or the minimum controlling variable limit.

26. The closed-loop control system as defined by claim 24, wherein the primary controller and/or at least one of the secondary controllers is embodied such that an integrator windup is avoidable if the controlling variable reaches the maximum controlling variable barrier or the minimum controlling variable barrier or the maximum controlling variable limit or the minimum controlling variable limit.

27. The closed-loop control system as defined by claim 21, wherein the closed-loop control system has a model module, and the model module has a model of the controlled system.

28. The closed-loop control system as defined by claim 26, wherein the closed-loop control system has a model module, and the model module has a model of the controlled system.

29. The closed-loop control system as defined by claim 21, wherein the controlled system is at least one fuel cell.

30. The closed-loop control system as defined by claim 28, wherein the controlled system is at least one fuel cell.

31. A fuel cell system having at least one fuel cell and at least one closed-loop control system as defined by claim 21.

32. A control method for a controlled system, wherein
a controlling variable is generated within an interval between a maximum controlling variable barrier and a minimum controlling variable barrier;
on the basis of the controlling variable, at least one state variable of the controlled system is ascertained;
at least one of the maximum controlling variable barrier and the minimum controlling variable barrier is changed as a function of the state variable; and
the controlling variable is converted by the controlled system into a controlled variable.

33. The control method as defined by claim 32, wherein the controlling variable is generated within a controller interval between a maximum controlling variable limit and a minimum controlling variable limit, and the interval between the controlling variable barriers is located within the controller interval.

34. The control method as defined by claim 32, wherein the maximum controlling variable barrier is calculated as follows:
$${u}_{max} = {u}_{max\_real} - max [ {\sum }_{ip} Δ {u}_{max , ip} , {u}_{max\_real} - {u}_{min} ]$$

35. The control method as defined by claim 33, wherein the maximum controlling variable barrier is calculated as follows:
$${u}_{max} = {u}_{max\_real} - max [ {\sum }_{ip} Δ {u}_{max , ip} , {u}_{max\_real} - {u}_{min} ]$$

36. The control method as defined by claim 32, wherein the minimum controlling variable barrier is calculated as follows:
$${u}_{min} = {u}_{min\_real} + min [ {\sum }_{in} Δ {u}_{min , ip} , {u}_{max} - {u}_{min\_real} ]$$

37. The control method as defined by claim 35, wherein the minimum controlling variable barrier is calculated as follows:
$${u}_{min} = {u}_{min\_real} + min [ {\sum }_{in} Δ {u}_{min , ip} , {u}_{max} - {u}_{min\_real} ]$$

38. The control method as defined by claim 32, wherein the controlled system and/or the state variable is modeled.

39. The control method as defined by claim 37, wherein the controlled system and/or the state variable is modeled.

40. The control method as defined by claim 28, wherein for performing the control method, a closed-loop control system is provided for a controlled system for specifying at least one controlling variable to the controlled system, the closed-loop control system having
a primary controller, for generating the controlling variable within an interval between a maximum controlling variable barrier and a minimum controlling variable barrier;
at least one measuring means for determining a controlled variable of the controlled system;
at least one measurement system for ascertaining at least one state variable of the controlled system; and
at least one secondary controller, for varying the maximum controlling variable barrier and the minimum controlling variable barrier as a function of the state variable.
